(19) United States
(12) Patent Application Publication
(10) Pub. No.: US 2015/0307815 A1
(43) Pub. Date: Oct. 29, 2015

(54) CLEANING PRODUCTS FORMULATIONS

(71) Applicant: WFABRILL INDÚSTRIA E COMÉRCIO LTDA. - EPP, São Caetano do Sul - SP (BR)

(72) Inventors: Wilson RAINATTO, São Caetano do Sul (BR); Giuliano Carlo RAINATTO, São Caetano do Sul (BR)

(21) Appl. No.: 14/650,009

(22) PCT Filed: Nov. 8, 2013
(86) PCT No.: PCT/BR2013/000479

§ 371 Date: Jun. 5, 2015

(30) Foreign Application Priority Data
Dec. 7, 2012 (BR) BR1020120312255

(51) Int. Cl. C11D 3/33; A01N 33/12; A01N 43/80; C11D 3/10

(52) U.S. Cl. CPC C11D 3/33; C11D 3/10; A01N 33/12; A01N 43/80

(57) ABSTRACT

The present abstract refers to an invention patent for cleaning products, belonging to the field of miscellaneous cleaning products provided with formulations containing Sodium Carbonate (Soda ash—Na₂CO₃) and Citric Acid (C₆H₈O₇) with salt solving functions and EDTA Tetrasodium PO (Ethylenediaminetetraacetic acid—C₁₀H₁₆N₂O₈) with the function to increase the salt solubility coefficient; a set of active ingredients, selected according to the desired cleaning product; and a set of auxiliary ingredients, all selected to fulfill their functions in the formulations and to enable the conformation of the tablets constituted of individual doses of the products by compression.

### INTRODUCTION

The present descriptive report refers to a patent for invention of cleaning products, belonging to the field of miscellaneous cleaning products provided with formulations adequate to be presented in the form of tablets soluble in water and which incorporate active substances according to the cleaning they are designated to.

### STATE OF ART

As it is well known, the cleaning of environments or vehicles or use objects or other objects, which enter in contact with people is responsible for their comfort, and above all, for the maintenance of their health. For this reason, there is a big number of cleaning products offered in general to the market, such as: detergents, disinfectants, degreasers and others. Generally, these products are presented as non-soluble liquids, which are directly applied on the cleaning location or of the type dilutable before being applied on the cleaning location. Generally, these products are adequately adapted to their functions.

The non-dilutable products are more practical, as they are applied directly on the cleaning location. However, they require high consumption and consequently lead to higher expenses for the user, which is not desirable.

On the other hand, the dilutable products are less practical, because they need to be diluted before use, and in general, they do not guarantee total dilution, which also results in loss for the user.

These products also present a problem common for all of them, which is being liquid, which leads to relatively high costs of conditioning, storage and transport.

Thus, new solutions have been desirable for these products, particularly to what refers to their presentations.

### OBJECTIVES OF THE INVENTION

Thus, the objective of the present invention patent is to provide cleaning products formulations in general, which surpass the inconveniences with the usual liquid.

Another objective is to provide products, which overcome the problems above and for this reason, they do not present levels of complexity in obtaining to make them not interesting compared to the usual ones.

Another objective is to provide products with adequate cost.

### SUMMARIZED DESCRIPTION OF THE INVENTION

Thus, considering the problems referred above and with the purpose to overcome them and aiming at fulfilling the listed objectives, the cleaning products formulations, object of the present invention patent, were developed, to provide cleaning products in the form of tablets and for this reason, they essentially comprehend: a set of auxiliary ingredients for the tablet dissolution: Sodium Carbonate, Citric Acid and EDTA Tetrasodium, common to all formulations and which have the function to favor the tablet dissolution, when in contact with water; a set of active inputs, selected according to the type of cleaning the product is designated to; and a set of auxiliary ingredients, all selected to fulfill their functions in the formulation and to provide conformation by compression for the formation of the tablet.

This presentation of the cleaning products in tablets solves the problems with the liquid cleaning products, because it is practical and fast and used just dissolving the tablet in water.

Another advantage provided by the present formulation is obtaining in a simple way.

Another advantage provided by the present presentation in tablet is the low cost for conditioning, storage and transport compared to the similar liquid products.

### DETAILED DESCRIPTION OF THE INVENTION

As provided in the invention, the formulations, objects of the present patent, are cleaning products and arranged for these products to be presented in tablets soluble in water.

For this purpose, the formulations essentially comprehend:

A set of ingredients with auxiliary function to dissolve the tablet, containing: Sodium Carbonate (Soda ash—Na₂CO₃) and Citric Acid (C₆H₈O₇) with salt-solvent function and EDTA Tetrasodium PO (Ethylenediaminetetraacetic acid—C₁₀H₁₆N₂O₈) with the function to increase the salt solubility coefficient;

A set of active ingredients, selected according to the desired cleaning product; and

A set of auxiliary ingredients, all selected to fulfill their functions in the formulations and to enable conformation by compression of tablets constituted of individual doses of the products.

Detailing, Sodium Carbonate, Citric Acid and EDTA Tetrasodium PO are used in different proportions in the formulations of each cleaning product and act in a way that when the tablet is placed in the presence of water, Sodium Carbonate releases CO₂ through contact with the Citric Acid, dissolving the material. Then, EDTA Tetrasodium PO, which is an important metal ion chelating agent and easily soluble in water, breaks its hardness and helps it accepting the quantity of salt in the medium, i.e., increases the salt solubility coefficient. Simultaneously, the active ingredients act, performing the cleaning.

In a first embodiment, the formulation is a Degreasing Cleaning product in a tablet and comprehends:

A set of ingredients with the function to assist in the tablet dissolution, containing: Sodium Carbonate in the range from 29.25% to 37.25%; Citric Acid in the range from 16.5% to 24.5% and EDTA Tetrasodium in the range from 1.00% to 4.00%. Preferentially, 33.25% Sodium Carbonate; 20.50% Citric Acid and 1% EDTA Tetrasodium.

A set of active substances, containing: Caustic Soda Flakes 50%, (Sodium Hydroxide—N₂OH), with alkalizing function, in the range from 32.00% to 40.00%; TEXAPON ZACD [Sodium Laureth Sulfate (powder)—(CH₃(CH₂)₁₀CH₂(OCH₂CH₂)ₙOSO₃Na)], with degreasing function, in the range from 1.00% to 4.00%. Preferentially: 36% Caustic Soda Flakes 50%; and 1.00% TEXAPON ZACD.

A set of auxiliary ingredients, containing: Sulfonic Acid 90% (H—S(═O)₂—OH), in the range from 4.00% to 12.00% and Fluorescein Stain in the range from 0.1% to 0.5%. Preferentially, 8.00% Sulfonic Acid 90% and 0.1% Fluorescein Stain.

The process of obtaining Degreasing Cleaning Product in tablets, with the formulation above, essentially consists of: selection, weighing, mixture and rest of the ingredients and formation of portions of the mixed ingredients and compression for the tablet formation, constituted of individual doses of the product. The tablets may have different weights according to the action intended for the tablets.

When in use, the degreasing tablet is placed in the presence of dilution water. The Set of ingredients with auxiliary function in the tablet dissolution (Sodium Carbonate; Citric Acid and EDTA Tetrasodium) acts in the way described above.

Simultaneously, the Caustic Soda is introduced as active matter in the cleaning, providing alkaline medium. Texapon Zacd is an anionic surfactant, biodegradable, with detergent and emulsion function and removes fat. In the present composition, Texapon Zacd is used as tensioactive, easily diluted in water.

Sulfonic Acid functions as an agglutinating agent in the reaction.

These components are diluted in a homogenized way by means of releasing CO₂ in the reaction, agitating the water and making the reaction stabilized.

In another embodiment, the formulation is a Disinfecting Cleaning Product in tablets and comprehends:

A set of ingredients with auxiliary function in the tablet dissolution, containing: Sodium Carbonate in the range from 50.945% to 58.945%; Citric Acid in the range from 31.00% to 39.00% and EDTA Tetrasodium 1.00% to 4.00%. Preferentially, 54.945% Sodium Carbonate; 35.00% Citric Acid and 1% de EDTA Tetrasodium.

A set of active ingredients containing: Benzalkonium Chloride 80% (alkyldimethylbenzylammonium chloride—CH₃(CH₂)14CH₂N+(CH3)3CL−) with disinfecting function, in the range from 0.50% a 6.00%; Nonylphenol Ethoxylate 9.5 Moles (C₉H₁₉O(CH₂CH₂O)9.65 H) with detergent function, in the range from 0.5% to 7.00% and BQ Fabrill Green with odorant function, in the range from 0.5% to 8.00%. Preferentially, 2% Benzalkonium Chloride 80%; 3% Nonylphenol Ethoxylate 9.5 Moles; and 4.00% BQ Fabrill Green.

A set of auxiliary ingredients containing: Turquoise Blue Stain in the range from 0.1% to 0.5% and Isothiazolin (C₄H₄CINOS-IPEL BHD 208) with technical conserving function, in the range from 0.035% to 4.035%. Preferentially, 0.1% Turquoise Blue Stain; and 0.035% Isothiazolin IPEL BHD 208.

The process of obtaining the Disinfecting Cleaning Product in tablets, with the formulation above, essentially consists of selection, weighing, mixing and rest of the ingredients and formation of portions of the mixed ingredients and compression for the formation of the tablets consisting of individual doses of the product. The tablets may have different weights, according to the action capacity intended for them.

When in use, the tablet is placed in the presence of water for dissolution. The set of ingredients with diluting function (Sodium Carbonate; Citric Acid and EDTA Tetrasodium) acts in the way described above.

Benzalkonium Chloride 80% is a quaternary ammonium anti-septic, which acts in the formulation a powerful bactericide. This component has a disinfecting action; it is soluble in water, surfactant action and when in aqueous solution, it decomposes into a complex and relatively broad cation, responsible for the surface activity, and a smaller inactive anion, chemically homogenizing the reaction with the composition components.

Nonylphenol Ethoxylate 9.5 Moles acts basically as a detergent.

BQ Fabrill Green acts as an environment odorant.

These components are diluted in a homogenized way, by release of CO₂ in the reaction, agitating the water and making the reaction stabilized.

In another embodiment, the formulation is a Detergent Cleaning Product in tablets and comprehends:

A set of ingredients with auxiliary function in the tablet dissolution, containing: Sodium Carbonate in the range from 53.90% to 61.90%; Citric Acid Anhydrous in the range from 21.50% to 29.50%, this one and Sodium Carbonate in quantities designated to fulfill the auxiliary function in the tablet dissolution and pH control; and EDTA Tetrasodium 1.00% to 5.00%. Preferentially: 57.90% Sodium Carbonate; 25.50% Citric Acid and 1% EDTA Tetrasodium.

A set of active ingredients, containing: Triethanolamine 85%, with alkalizing function, in the range from 0.5% to 8.5%; TEXAPON ZACD, with detergent function, in the range from 0.5% to 7.00% and Sulfonic Acid 90%, with the function of cleaning raw material, in the range from 4.00% to 12.00%. Preferentially: 4.50% Triethanolamine 85%; 3.00% Texapon ZACD and 8.00% Sulfonic Acid 90%.

A set of auxiliary ingredients: Turquoise Blue Stain Azul in the range from 0.1% to 4.1%, preferentially 0.1%.

The process of obtaining the Detergent Cleaning product in tablets, with the formulation above, essentially consists of selection, weighing, mixing and rest of the ingredients and formation of portions of the mixed ingredients and compression for the formation of the tablets constituted of individual doses of the product. The tablets may have different weights, according to the action capacity intended for them.

When in use, the tablet is placed in the presence of water for dissolution. The Set of ingredients with auxiliary function in the tablet dissolution (Sodium Carbonate; Citric Acid and EDTA Tetrasodium) acts in the way described above.

Triethanolamine 85% is introduced as active matter in the cleaning, providing alkaline medium. Texapon ZACD is an anionic surfactant, bio-degradable, with detergent and emulsion action and removes fat. In the present formulation, Texapon Zacd is used as tensioactive, easily diluted in water. Sulfonic Acid 90% has the function of cleaning raw material in the formulation.

These components are diluted in a homogenized way, by releasing CO₂ in the reaction, agitating the water and making the reaction stabilized.

In another embodiment, the formulation is a Disinfectant Cleaning Product for Chemical Toilet in tablets and comprehends:

A set of ingredients with auxiliary function in the tablet dissolution, containing: Sodium Carbonate in the range from 41.00% to 49.00%; Citric Acid in the range from 35.00% to 43.00%; and EDTA Tetrasodium 1.00% to 5.00%. Preferentially: 45.00% Sodium Carbonate; 39.00% Citric Acid and 1% EDTA Tetrasodium.

A set of active ingredients containing: Benzalkonium Chloride 80% with disinfecting function, in the range from 0.5% to 7.00%; BQ Fabrill Green, with odorant function, in the range from 8.00% to 16.00%; Nonylphenol Ethoxylate 9.5 Moles with detergent function, in the range from 0.1% to 4.10%. Preferentially: 3.00% Benzalkonium Chloride 80%; 12.00% BQ Fabrill Green; and 0.1% Nonylphenol Ethoxylate 9.5 Moles.

A set of auxiliary ingredients: Cutting Green Crysanol in the range from 0.5% to 4.5% and Isothiazolin IPEL BHD 208 with technical conserving function, in the range from 0.035% to 4.035%. Preferentially: 0.5% Cutting Green Crysanol and 0.035% Isothiazolin IPEL BHD 208.

The process of obtaining the Disinfectant Cleaning Product for chemical toilet in tablets, with the formulation above, essentially consists of selection, weighing, mixing and rest dos ingredients and formation of portions of the mixed ingredients and compression for the formation of the tablets constituted of individual doses of the product. The tablets may have different weights, according to the action capacity intended for them.

When in use, the tablet is placed in the presence of water for dissolution. The Set of ingredients with auxiliary function in the tablet dissolution (Sodium Carbonate; Citric Acid and EDTA Tetrasodium) acts in the way described above.

Benzalkonium Chloride 80% is a Benzalkonium Chloride 80% is a quaternary ammonium anti-septic, which acts in the formulation a powerful bactericide. This component has a disinfecting action; it is soluble in water. This is the maximum active component, which in addition to disinfecting, has also a surfactant action and when in aqueous solution, it decomposes into a complex and relatively broad cation, responsible for the surface activity, and a smaller inactive anion, chemically homogenizing the reaction with the composition components. BQ Fabrill Green acts as environment odorant. Nonylphenol Ethoxylate 9.5 Moles basically acts as detergent.

These components are diluted in a homogenized way, by releasing CO2 in the reaction, agitating the water and making the reaction stabilized.

In another embodiment, the formulation is a Cleaning product for Automotive Vehicle Windscreens in tablets and comprehends:

A set of ingredients with auxiliary function in the tablet dissolution, containing: Sodium Carbonate in the range from 45.00% to 52.00%; Citric Acid Anhydrous in the range from 45.00% to 52.00%; and EDTA Tetrasodium PO in the range from 1.00% to 2.00%. Preferentially: 48.50% Sodium Carbonate; 48.50% Citric Acid and 1.5% EDTA Tetrasodium PO.

A set of active ingredients containing: Sulfonic Acid 90%, with the function of cleaning raw material in the range from 0.60% to 2.20%; Texapon ZACD, with detergent function, in the range from 0.5% to 2.0%. Preferentially: 1.4% Sulfonic Acid 90%; and 1.25% Texapon ZACD.

A set of auxiliary ingredients: Turquoise Blue Stain in the range from 0.05% to 0.20%; and IPEL BHD 208 Isothiazolin with technical conserving function in the range from 0.05% to 0.55%. Preferentially: 0.125% Turquoise Blue Stain; and 0.3% IPEL BHD 208 Isothiazolin.

The process of obtaining the Cleaning product for Automotive Vehicle Windscreens in tablets, with the formulation above, essentially consists of selection, weighing, mixing and rest of the ingredients and compression of portions of the mixed ingredients for the formation of the tablets constituted of individual doses of the product. The tablets may have different weights, according to the action capacity intended for them.

When in use, the tablet is placed in the presence of water for dissolution in the vehicle windscreen cleaning water tank. The Set of ingredients with auxiliary function in the tablet dissolution (Sodium Carbonate; Citric Acid and EDTA Tetrasodium) acts in the way described above.

Sulfonic Acid 90% acts as cleaning raw material in the formulation. Texapon ZACD is an anionic surfactant, biodegradable, with detergent and emulsion action and removes fat. In the present formulation, Texapon Zacd is used as tensioactive, easily diluted in water.

These components are diluted in a homogenized way, by releasing CO₂ in the reaction, agitating the water and making the reaction stabilized.

Within the basic solutions described above, it is claimed is that the cleaning products and tablets and their formulations, objects of the present patent, may present qualitative and quantitative modifications, within the scope of the petitioned protection.

1. A formulation for a cleaning product, the formulation comprising:
(a) sodium carbonate (Soda ash—Na₂CO₃) and citric acid (C₆H₈O₇) with salt solvent function;
(b) EDTA Tetrasodium PO (Ethylenediaminetetraacetic acid—C₁₀H₁₆N₂O₈) for increasing the salt solubility coefficient;
(c) a set of active ingredients, selected according to the desired cleaning product; and
(d) a set of auxiliary ingredients, all selected in order to fulfill predetermined desired functions in the formulations and to enable conformation of the tablets constituted of individual doses of the products by compression.

2. The formulation according to claim 1 further containing a degreaser, and wherein:
sodium carbonate in the range from 29.25% to 37.25%;
citric acid in the range from 16.5% to 24.5% and EDTA tetrasodium 1.00% to 4.00%;
Caustic Soda Flakes 50%, in the range from 32.00% to 40.00%;
TEXAPON ZACD, in the range from 1.00% to 4.00%;
sulfonic acid 90%, in the range from 4.00% to 12.00%; and
fluorescein stain in the range from 0.1% to 0.5%.

3. The formulation according to claim 2, having its constituents as follows:
33.25% sodium carbonate;
20.50% citric acid;
1% EDTA tetrasodium;
36% Caustic Soda Flakes 50%;
1.00% TEXAPON ZACD;
8.00% sulfonic acid 90% and
0.1% fluorescein stain.

4. The formulation according to claim 2 presented in a tablet form.

5. The formulation according to claim 1 further containing a disinfectant cleaning product, and wherein:
sodium carbonate is in the range from 50.945% to 58.945%;
citric acid is in the range from 31.00% to 39.00%;
EDTA tetrasodium is in the range of 1.00% to 4.00%;
benzalkonium chloride 80%, in the range from 0.50% to 6.00%;
nonylphenol ethoxylate 9.5 moles, in the range from 0.5% to 7.00%;
BQ Fabrill Green is in the range from 0.5% to 8.00%;
Turquoise Blue Stain is in the range from 0.1% to 0.5% and
isothiazolin is in the range from 0.035% to 4.035%.

6. The formulation according to claim 5, wherein its consistuients are:
54.945% sodium carbonate;
35.00% citric acid;
1% EDTA tetrasodium;
2% benzalkonium chloride 80%;
3% nonylphenol ethoxylate 9.5 moles;
4.00% BQ Fabrill Green;
0.1% Turquoise Blue Stain; and
0.035% isothiazolin.

7. The formulation according to claim 5 presented in a tablet form.

8. The formulation according to claim 1 further containing a cleaning product detergent and wherein:
sodium carbonate in the range from 53.90% to 61.90%;
citric acid anhydrous in the range from 21.50% to 29.50%;
EDTA tetrasodium 1.00% to 5.00%;
triethanolamine 85%, in the range from 0.5% to 8.5%;
TEXAPON ZACD, in the range from 0.5% to 7.00%;
sulfonic acid 90%, in the range from 4.00% to 12.00%; and
Turquoise Blue Stain in the range from 0.1% to 4.1%.

9. The formulation according to claim 8, wherein its consituients are:
57.90% sodium carbonate;
25.50% citric acid anhydrous;
1% EDTA tetrasodium;
4.50% triethanolamine 85%;
3.00% Texapon ZACD;
8.00% sulfonic acid 90%; and
0.1% Turquoise Blue Stain.

10. The formulation according to claim 8 presented in a tablet form.

11. The formulation according to claim 1 further containing a disinfectant cleaning product for chemical toilet; and wherein
sodium carbonate in the range from 41.00% to 49.00%;
citric acid anhydrous in the range from 35.00% to 43.00%;
EDTA tetrasodium 1.00% to 5.00%;
Benzalkonium Chloride 80%, in the range from 0.5% to 7.00%;
BQ Fabrill Green, in the range from 8.00% to 16.00%;
nonylphenol ethoxylate 9.5 Moles, in the range from 0.1% to 4.10%;
Cutting Green Crysanol in the range from 0.5% to 4.5% and
Isothiazolin, in the range from 0.035% to 4.035%.

12. The formulation according to claim 11 wherein consitiuients of its formulation are:
45.00% sodium carbonate;
39.00% citric acid;
1% EDTA tetrasodium;
3.00% Benzalkonium Chloride 80%;
12.00% BQ Fabrill Green;
0.1% nonylphenol ethoxylate 9.5 Moles;
0.5% Cutting Green Crysanol and
0.035% Isothiazolin.

13. The formulation according to claim 11 presented in a tablet form.

14. The formulation according to claim 1 further containing a cleaning product for automotive vehicle windshield and wherein constituients of its formulation are:
sodium carbonate in the range from 45.00% to 52.00%;
citric acid anhydrous in the range from 45.00% to 52.00%;
EDTA tetrasodium PO in the range from 1.00% to 2.00%;
sulfonic acid 90%, in the range from 0.60% to 2.20%;
Texapon ZACD, in the range from 0.5% to 2.0%;
Turquoise Blue Stain in the range from 0.05% to 0.20%; and
Isothiazolin the range from 0.05% to 0.55%.

15. The formulation according to claim 14 wherein its constuients are:
48.50% sodium carbonate;
48.50% citric acid;
1.5% EDTA tetrasodium PO;
1.4% sulfonic acid 90%;
1.25% Texapon ZACD;
0.125% Turquoise Blue Stain; and
0.3% Isothiazolin.

16. The formulation according to claim 14 presented in a tablet form.
